(19) United States
(12) Patent Application Publication
(10) Pub. No.: US 2004/0212687 A1
(43) Pub. Date: Oct. 28, 2004

(54) System for controlling a camera resource in a portable device

(76) Inventor: Srinivas Patwari, San Diego, CA (US)

Correspondence Address: Qualcomm Incorporated, Patents Department, 5775 Morehouse Drive, San Diego, CA, 92121-1714, US

(21) Appl. No.: 10/832,718

(22) Filed: Apr. 26, 2004

Related U.S. Application Data
(60) Provisional application No. 60/465,533, filed on Apr. 25, 2003.

(51) Int. Cl. H04N 11/00

(52) U.S. Cl. 348/211.13

(57) ABSTRACT

A system for controlling a camera resource in a resource-limited portable device. A method is provided for operating a camera system to allow an application to control a camera resource in a portable device. The method includes activating the camera system, wherein the camera system is operable to control the camera resource, providing an application program interface (API) to receive instructions from the application, receiving an instruction from the application via the API, wherein the instruction identifies a camera function to be performed, and performing the camera function identified by the instruction.

### CROSS REFERENCE TO RELATED APPLICATIONS

This application claims benefit of priority from U.S. provisional application 60/465,533, filed Apr. 25, 2003. This application also claims benefit of priority from U.S. patent application Ser. No. 10/453,091, filed Jun. 2, 2003. The contents of these documents are incorporated herein by reference.

### FIELD

The present invention relates generally to image acquisition and processing in portable devices, and more particularly, to a system for controlling a camera resource in a portable device having an embedded controller.

### DESCRIPTION OF THE RELATED ART

Advances in technology have resulted in smaller and more powerful personal computing devices. For example, there currently exist a variety of portable wireless telephones, personal digital assistants (PDAs), and paging devices that are small, lightweight, and can be easily carried by users. Typically, these devices include an embedded controller with limited memory resources. For example, the amount of available memory and processing capability may be limited by the small size of the device.

There is an increasing need for personal computing devices to handle larger amounts of data and to execute programs that are more sophisticated. For example, users are demanding applications that provide extensive image processing. In this area, users would like to have portable devices that include camera resources, which can be controlled to acquire still images and video clips for processing and/or transmission.

In order to capture images on portable devices, it is necessary to control the camera resources of those devices. For example, one type of portable device may include a low-resolution camera resource that is design to acquire only still images, and another type of portable device may include a larger and higher-resolution camera resource with zoom capabilities designed to capture full motion video. Thus, each type of portable device may have a different camera resource with which to capture image content. Therefore, application developers must overcome compatibility problems when developing applications for use on a wide variety of portable devices, which may have different configurations and camera resources.

One technique used to overcome compatibility problems requires that an application be specifically created to run on a portable device having a particular camera resource. For example, if an application developer develops an application that runs on a portable device to acquire video images, the developer must tailor the application to be exactly compatible with the camera resource available on that particular device.

Unfortunately, it is expensive and inefficient to produce applications for use on a wide variety of portable devices that are tailored for the particular camera resources found on each device. For example, an application developer would need to modify an application for use on different portable devices based on the available camera resource, thereby requiring multiple versions of the same application to be produced. Also, the application developer would have to constantly update its applications as new camera resources become available.

Another technique proposed to control camera resources on portable devices involves the use of multimedia platforms generally available on larger computer systems. For example, there are large and complex multimedia platforms developed for use on desktops, servers, or other relatively large computing devices. However, these types of platforms would be highly inefficient if used on a portable device having limited resources, because these systems generally require a large number of software interfaces to be created between an application and program modules loaded on the device. Thus, in addition to being very complex, these systems are memory and processing intensive, which is not compatible with the limited processing capacity available on typical portable devices.

Therefore, what is needed is a system that allows applications to efficiently and easily access and control camera resources on a variety of portable devices to capture, encode, manipulate, and display still images and video. The system should be compact and designed to operate using the limited resources available on typical portable devices. For example, the system should not required extensive software interfaces between program modules that are large, inefficient, and not practical for use on a small resource limited device. The system should operate to allow all types of camera resources to be controlled and provide an extensible architecture that allows for the control of new camera resources as they become available.

### SUMMARY OF THE INVENTION

In one or more embodiments, a camera system, including methods and apparatus, is provided for controlling camera resources on portable devices. For example, one portable device may be a wireless telephone with an embedded controller and limited memory resources that includes a camera device. In one or more embodiments, the camera system comprises a small and efficient program that runs on the portable device to allow applications executing on the device to control the camera resource using a simple interface. Thus, the camera system is particularly well suited for use in portable devices having embedded controllers with limited memory resources.

In one embodiment, the camera system provides a simple, efficient, and powerful way to access and control a camera resource on a portable device and allows static and dynamic applications to (1) capture snapshot and video images, (2) set camera settings and configuration parameters, (3) manipulates captured image and video frames, (4) add additional information like position information to the image and video frame, (5) encode captured image and video frames, (6) display captured image and video frames, and (7) receive camera events asynchronously.

In one or more embodiments, the camera system comprises a small program module that is instantiated by an executing application. The application then uses a simple application program interface (API) provided by the program module to perform all camera operations. The events from the camera are sent to the application via a registered callback function. The program module consumes minimal memory and provides efficient execution by directly accessing device-level driver software to perform all the camera operations.

In one embodiment, a method is provided for operating a camera system to allow an application to control a camera resource in a portable device. The method comprises activating the camera system, wherein the camera system is operable to control the camera resource, providing an application program interface (API) to receive instructions from the application, receiving an instruction from the application via the API, wherein the instruction identifies a camera function to be performed, and performing the camera function identified by the instruction.

In another embodiment, apparatus is provided for operating a camera system to allow an application to control a camera resource in a portable device. The apparatus comprises means for activating the camera system, wherein the camera system is operable to control the camera resource. The apparatus also comprises means for providing an application program interface (API) to receive instructions from the application. The apparatus also comprises means for receiving an instruction from the application via the API, wherein the instruction identifies a camera function to be performed. The apparatus also comprises means for performing the camera function identified by the instruction.

In another embodiment, a computer-readable medium is provided that comprises instructions, which when executed by a processor in a portable device, operate to provide a camera system that allows an application to control a camera resource in the portable device. The computer-readable media comprises instructions for activating the camera system, wherein the camera system is operable to control the camera resource, instructions for providing an application program interface (API) to receive API instructions from the application, instructions for receiving an API instruction from the application via the API, wherein the API instruction identifies a camera function to be performed, and instructions for performing the camera function identified by the API instruction.

In another embodiment, apparatus is provided for operating a camera system to allow an application to control a camera resource in a portable device. The apparatus comprises logic for activating the camera system, wherein the camera system is operable to control the camera resource, and further comprises logic for providing an application program interface (API) to receive instructions from the application. The apparatus also comprises logic for receiving an instruction from the application via the API, wherein the instruction identifies a camera function to be performed, and further comprises logic for performing the camera function identified by the instruction.

Other aspects, advantages, and features of the present invention will become apparent after review of the hereinafter set forth Brief Description of the Drawings, Detailed Description of the Invention, and the claims.

### BRIEF DESCRIPTION OF THE DRAWINGS

The foregoing aspects and the attendant advantages of the embodiments described herein will become more readily apparent by reference to the following detailed description when taken in conjunction with the accompanying drawings wherein:

FIG. 1 shows a data network that includes a portable wireless device with an embedded controller suitable for implementing one embodiment of a camera system;

FIG. 2 shows a block diagram illustrating one embodiment of the portable device of FIG. 1 that includes one embodiment of an ICamera system that operates to allow an application to control a camera resource on the device;

FIG. 3 shows a detailed block diagram of one embodiment of the ICamera system of FIG. 2;

FIG. 4 shows one embodiment of a state machine provided by one embodiment of an ICamera system to allow an application to control a camera resource on a portable device; and

FIG. 5 shows one embodiment of a method for operating an ICamera system to allow an application to control a camera resource in a portable device.

### DETAILED DESCRIPTION

The following detailed description describes a camera system, including methods and apparatus, for controlling a camera resource in a portable device. In one or more embodiments, the portable device has an embedded controller and limited resources (i.e., limited memory capacity), and the camera system operates to allow application programs to control the camera resource using a single interface.

In one or more embodiments, the camera system interacts with a runtime environment executing on the device that is used to simplify operation of the device, such as by providing generalized calls for device specific resources. One such runtime environment is the Binary Runtime Environment for Wireless® (BREW™) software platform developed by QUALCOMM, Inc., of San Diego, Calif. In the following description, it will be assumed that the camera system is implemented on a portable device executing a runtime environment, such as the BREW software platform. However, one or more embodiments of the camera system are suitable for use with other types of runtime environments to control a camera resource on a portable device.

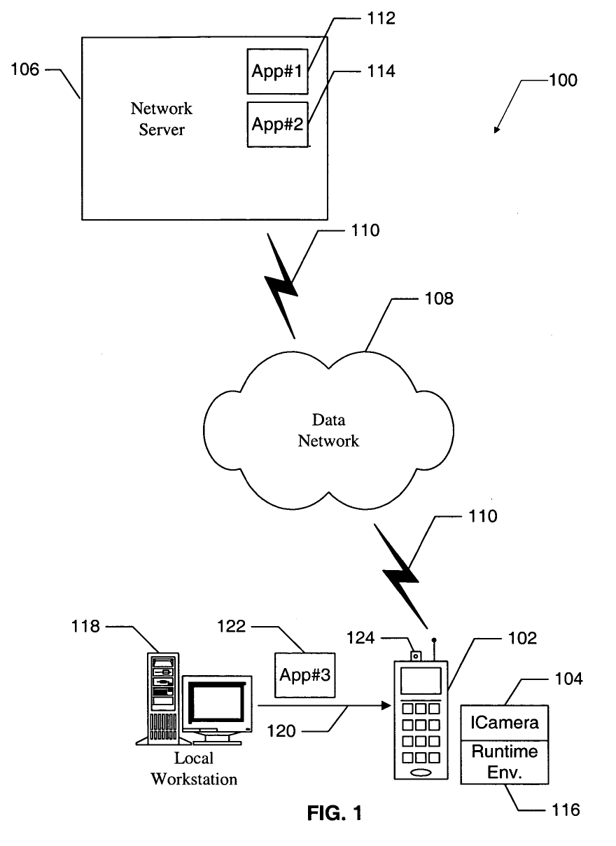

FIG. 1 shows a data network 100 that includes a portable wireless device 102 with an embedded controller suitable for implementing one embodiment of a camera system that will hereinafter be referred to as the “ICamera” system shown at 104. The ICamera system 104 operates to allow applications running on the device 102 to control a camera resource 124 located on the device 102. In one embodiment, the ICamera system 104 interacts with a runtime environment 116 executing on the device. For example, in one embodiment, the runtime environment 116 is the BREW software platform.

In one or more embodiments, the ICamera system 104 is suitable for use with a wide variety of portable devices. For example, other suitable portable devices include, but are not limited to, PDAs, email devices, pagers, tablet computers, mobile telephones or virtually any other type of portable device that includes a camera resource.

The wireless device 102 is operable to communicate with a network server 106 over a data network 108 using wireless communication channels 110. In one embodiment, the device 102 comprises a wireless telephone that may transmit and receive voice and/or other information over the network 108. The device 102 also operates to receive applications over the network 108. For example, applications 112 and 114 may be downloaded to the device 102 from the network server 106. These applications execute on the device 102 and use the device camera 124 to provide additional features and/or functionality to the device user. For example, the applications may acquire and process still images or video information from the device camera 124. It is also possible to download applications to the device 102 from any other network entity coupled to the network 108.

In one embodiment, the device 102 also couples directly to a local system, such as a local workstation 118, via a direct link 120. The device 102 is operable to download applications from the local workstation 118 using the direct link 120. For example, the application 122 is downloaded to the device 102 from the workstation 118 using the link 120.

The ICamera system 104 may be downloaded from the server 106 to the device 102 and operates on the device 102 to allow applications to control the camera 124. In another embodiment, the ICamera system 104 may be downloaded to the device 102 from the workstation 118 via the link 120, or may be installed in the device 102 during manufacture.

In one embodiment, the ICamera system 104 is provided as instructions stored on a computer-readable media, such as a floppy disk, and is loaded onto the system 118 for transmission to the device 102. In another embodiment, the ICamera system 104 may be stored on a computer readable media, such as a memory card (not shown), and plugged directly into the device 102, so that the ICamera system 104 may execute on the device 102. Thus, the device 102 may receive the ICamera system 104 in a wireless transmission, a wired transmission, or by retrieving it directly from a memory device.

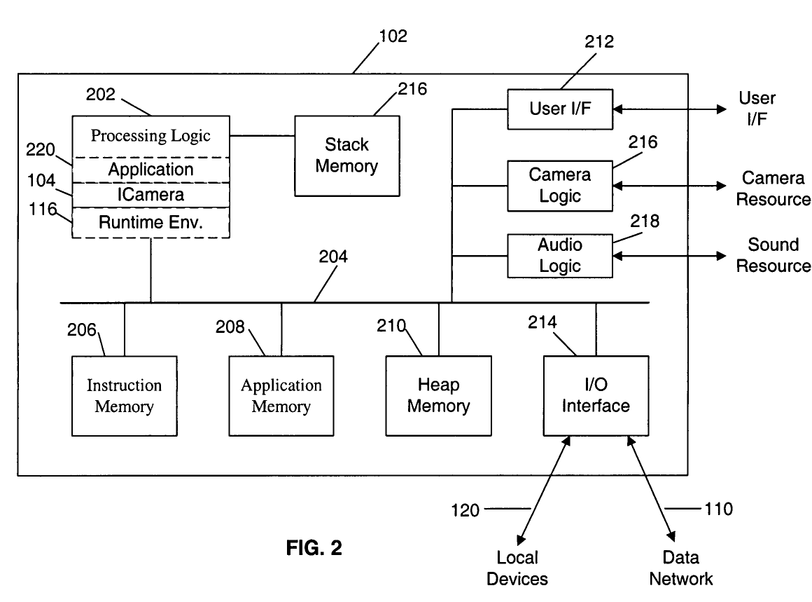

FIG. 2 shows a block diagram illustrating one embodiment of the device 102 that includes one embodiment of the ICamera system 104 that operates to allow an application to efficiently control a camera resource. The device 102 comprises processing logic 202 that is coupled to an internal data bus 204 and a stack memory 216. Also coupled to the internal data bus 204 are instruction memory 206, application memory 208, heap memory 210, user interface 212, camera logic 216, audio logic 218, and input/output (I/O) interface 214.

During operation of the device 102, the processing logic 202 executes program instructions stored in the instruction memory 206 to activate the runtime environment 116. The runtime environment 116 may be the BREW environment or other suitable runtime environment. To assist with instruction execution, the processing logic 202 utilizes the stack memory 216 to store program data or instructions on a temporary basis. For example, the processing logic 202 may store constants, variables, program addresses, pointers, instructions or other information items on the stack memory 216. In another embodiment, the processing logic 202 may store information on a temporary basis in the heap memory 210. The heap memory comprises virtually any type of memory suitable for the storage and retrieval of information by the processing logic 202.

In one or more embodiments, the processing logic 202 comprises a CPU, gate array, software, or logic comprising any combination of hardware and software. Thus, the processing logic 202 generally comprises logic to execute machine-readable instructions.

The instruction memory 206 comprises RAM, ROM, FLASH, EEROM, or any other suitable type of memory, or a combination thereof. In one embodiment, the instruction memory 206 is located internal to the device 102, and in another embodiment, the instruction memory 206 comprises a removable memory card or memory device that may be selectively attached to the device 102, and thereby couple to the internal bus 204. Thus, the instruction memory 206 may comprise virtually any type of memory that is capable of storing instructions that may be executed by the processing logic 202.

The user interface 212 receives user input, for example, from a keypad, pointing device, touch pad, or other input mechanisms to allow a user to interact with the device 102. The audio logic 218 comprises logic to output audio information to a device speaker(s), remote speaker(s) or audio system, or other type of sound resource. For example, a pair of remote speakers may receive the output of the audio logic 218 to render audio information to a device user.

The camera logic 216 comprises hardware and/or software logic that interfaces to the camera resource 124 installed on the device. For example, the device may include a CCD camera or any other type of camera resource. The cameral logic 216 interfaces to the camera resource to allow still and video images to be acquired from the camera resource. Thus, the camera logic 216 and the audio logic 218 may comprise hardware and/or software in any combination to allow the device 102 to capture or acquire visual and audio information.

The I/O interface 214 operates to transmit and receive information between the device 102 and external devices, systems, and/or networks. For example, in one embodiment, the I/O interface 214 comprises a radio transceiver circuit (not shown) that operates to transmit and receive information over a wireless data network using, for example, communication link 110. For example, the transceiver comprises circuitry that modulates information received from the processing logic 202 and converts the modulated information into high frequency signals suitable for wireless transmission. Similarly, the transceiver also comprises circuitry to convert received high frequency communication signals into signals suitable for demodulation and subsequent processing by the processing logic 202.

In another embodiment, the I/O interface 214 comprises a transceiver that operates to transmit and receive information over a hardwired communication link, such as a telephone line, to communicate with a remote system on a public data network, such as the, Internet.

In still another embodiment, the I/O interface 214 comprises circuitry that operates to communicate with local devices, such as the local workstation 116 using the link 120. The I/O interface 214 may also include circuitry (such as serial or parallel port logic) to communicate with a printer or other local computer or device, such as floppy disk or memory card. Thus, the I/O interface 214 may comprise any type of hardware, software, or logic comprising any combination of hardware and software to allow the device 102 to communicate with other local or remotely located devices or systems.

During operation of the device 102, execution of program instructions by the processing logic 202 causes the ICamera system 104 to be activated. For example, ICamera instructions may be stored in a computer-readable media, such as the instruction memory, and the execution of those instructions activates the ICamera system. The ICamera system 104 interacts with the runtime environment 116 to allow applications to efficiently control the camera resource 124 located on the device. For example, an application 220 is downloaded to the device 102 via the wireless network 108 and stored in the memory 208. In one embodiment, the application 220 is activated and interacts with the ICamera system 104 to control the operation of the camera resource 124 by controlling the camera logic 216. For example, the application 220 may operate to retrieve still images or video from the camera resource, or set selected parameters that control how the camera resource operates. To accomplish this, the application 220 interacts with a single program interface provided by the ICamera 104 system to perform all operations related to the camera resource.

It should be noted that the configuration of the device 102 is just one configuration suitable for implementing one embodiment of the ICamera system 104 to allow applications to efficiently control a camera resource on a portable device. It is also possible to implement the ICamera system 104 using other devices or device configurations within the scope of the present invention.

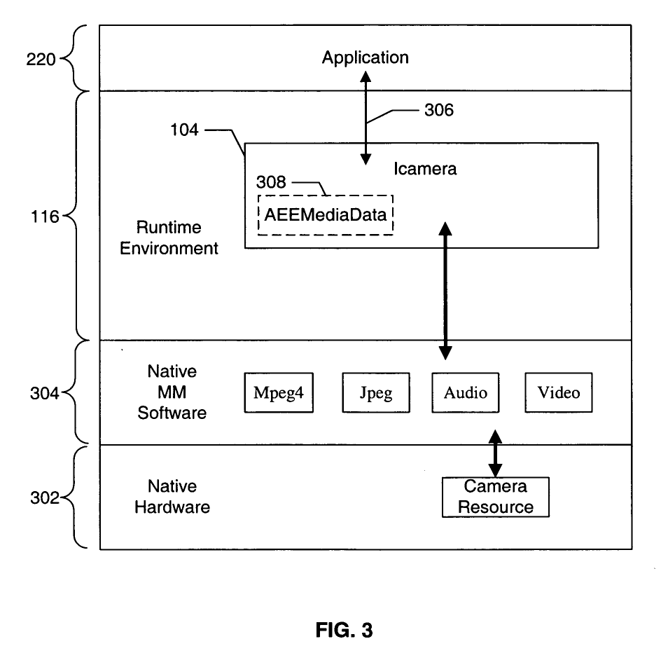

FIG. 3 shows a detailed functional diagram of one embodiment of the ICamera system 104 implemented on the device 102. The device 102 includes native hardware 302 that comprises a camera resource, for example, the camera 124. The device 102 also includes native multimedia software 304 that comprises audio and video program modules. These modules may include particular encoding modules, such as MPEG4 and JPEG encoding modules. These modules represent low-level software modules that are used to directly communicate with the native hardware 302. For example, the modules 304 interface with the camera resource 302. Although one embodiment is shown, it is also possible to have fewer or more multimedia software modules 304 and these modules may interface with all types of native hardware 302. Thus, other native hardware 302 and native software 304 configurations are possible within the scope of the invention.

During operation, the device 102 executes program instructions to activate the runtime environment 116, which in one embodiment, is the Brew environment. During operation of the device 102, the application 220 is then activated. For example, the user of the device downloads the application 220 from a data network (i.e., using the interface 214), and activates the application 220 via the user I/F 212. The application 220 was designed to control the camera resource of the device and was created using ICamera constructs as described herein. The application 220 instantiates the ICamera system 104, which allows the application 220 to use a simple application program interface (API) 306 provided by the ICamera system 104 to perform all operations related to the camera resource. A media data structure 308 may be optionally created by the ICamera system 104 to store and retrieve video information.

The ICamera system 104 interfaces and communicates with the native modules 304 via the runtime environment 116. For example, the runtime environment 116 may be the BREW platform, which provides generalized calls to access device specific resources. However, any suitable interface technique may be used to allow communication between the ICamera system 104 and the modules 304. Thus, it is possible for the ICamera system 104 to directly command any of the modules 304 to perform selected camera functions. For example, the ICamera system 104 may command the Mpeg4 module to obtain video data from the camera resource and encode it in the Mpeg4 format. Data obtained by the ICamera system 104 from the modules 304 may be stored in the data structure 308 thereby performing a “Record” function, and may be retrieved and displayed on a device display thereby performing a “Play” function.

Media Data Structure

The media data structure 308 operates to encapsulate camera data received by the ICamera system 104 from the native software 304. In one embodiment, the following structure defines a media data structure that provides a source/sink type and context-sensitive data associated with a media data type.

| | |
|---|---|
| typedef struct | |
| { | |
| AEECLSID clsData; | // Type of media data |
| void *pData; | // Context sensitive data |
| uint32 dwSize; | // Context sensitive data |
| } AEEMediaData; | |
| where the members are defined by: | |
| clsData | // Type of media data |
| pData | // Context sensitive data |
| dwSize | // Context sensitive data |

and where the following table gives details of context-sensitive data for predefined media data types where “Read/Write” means “Playback/Record” with respect to the camera resource of the device.

| clsData | Mode | pData | dwSize |
|---|---|---|---|
| MMD_FILE_NAME | Read/Write | File name | 0 |
| MMD_BUFFER: | Read/Write | Buffer ptr data size or | 0 |
| MMD_ISOURCE: | ReadWrite | ISource * data size or | 0 |

It should be noted that for playback, clsData can be set to the CLSID of any ISource-based class with pData set to the corresponding interface pointer.

In one embodiment, the ICamera system 104 provides a single interface 306 that allows an application to control a camera resource on a device. The interface 306 includes a set of ICamera API instructions that an application can execute to perform various camera related functions. A sample of the API instructions provided by the ICamera system is as follows.

| | | |
|---|---|---|
| 1. | ICAMERA_SetParm( ) | ;sets camera parameters |
| 2. | ICAMERA_GetParm( ) | ;gets camera parameters |
| 3. | ICAMERA_Preview( ) | ;starts preview (view-finder |
| | | mode) |
| 4. | ICAMERA_Pause( ) | ;pauses current operation |
| 5. | ICAMERA_Resume( ) | ;resumes current operation |
| 6. | ICAMERA_RecordSnapshot( ) | ;records snapshot |
| 7. | ICAMERA_RecordMovie( ) | ;records movie |
| 8. | ICAMERA_Stop( ) | ;issues stop command |
| 9. | ICAMERA_EncodeSnapshot( ) | ;encode snapshot image in |
| | | specified format (i.e., JPEG |
| | | format) |
| 10. | ICAMERA_SetMediaData( ) | ;sets media data |
| 11. | ICAMERA_RegisterNotify( ) | ;registers a notification function |
| 12. | ISHELL_CreateInstance ( ) | ;instantiates ICamera system |
| | | and so on. |

For example, the ICAMERA_SetParm( ) instruction may be executed by the application to instruct the ICamera system 104 to set specific parameters, settings, or variables associated with the camera resource of the device. In other embodiments, applications may execute one or more other ICamera API instructions (not shown above) that may be included in the ICamera system 104 to control virtually any function of the camera resource.

In one embodiment, the ICamera system 104 operates to allow an application to control the camera resource to take a snapshot and save it by performing the following steps.

1. The application program instantiates the ICamera system/interface using an “ISHELL_CreateInstance ( )” instruction and registers a callback function to receive asynchronous events.

2. An “ICAMERA_Preview( )” instruction starts the camera in preview mode allowing image frames to be received and displayed by the application via the registered callback function.

3. An “ICAMERA_SetMediaData( )” instruction sets the file name/buffer where the data needs to be recorded.

4. “ICAMERA_SetVideoEncode( )” and “ICAMERA_SetAudioEncode( )” instructions specify the encoding formats to be used to encode the image data from the camera resource and audio. For example, the encoding format may be JPEG or MPEG4 encoding. For example, the camera resource may have an associated microphone for audio recording.

5. An “ICAMERA_Recordsnapshot( )” instruction records and encodes the image into the specified destination.

In another embodiment, the ICamera system 104 operates to allow an application to control a camera resource to set camera operating parameters, such as a camera zoom parameter or brightness and contrast levels by executing the following API instructions.

1. An “ICAMERA_Setzoom( )” instruction is executed that sets the zoom level.

2. An “ICAMERA_SetBrightness( )” instruction is executed that sets the brightness level.

3. An “ICAMERA_SetContrast( )” instruction is executed that sets the contrast level.

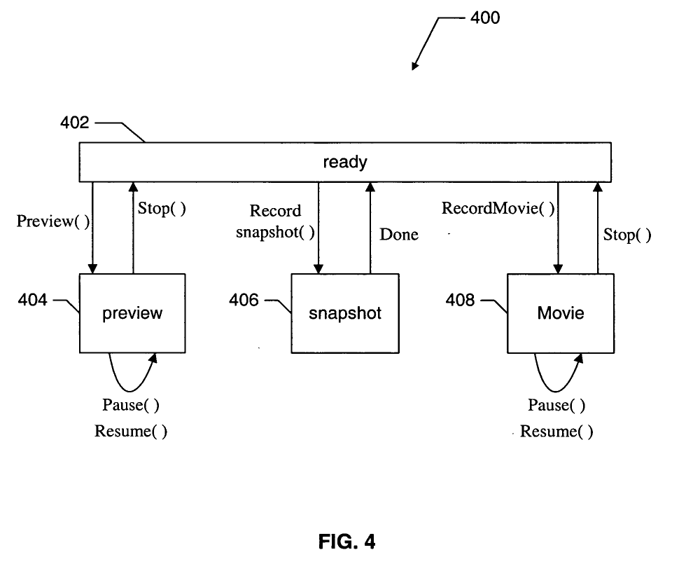

FIG. 4 shows one embodiment of a state machine 400 provided by one embodiment of an ICamera system to allow an application to control a camera resource on a portable device. After the application instantiates the ICamera system, the state machine 400 is in the READY state 402. The application may then issue ICamera API instructions to navigate to other states of the state machine 400, and thereby control the operation of the camera resource. For example, a Preview( ) command activates a preview state 404. A Record_snapshot( ) command activates a snapshot state 406 where an image snapshot is acquired from the camera resource. A Record_movie( ) command activates a movie state 408 where a video stream is acquired from the camera resource. The state machine 400 also allows additional instructions to control the operation of each state. For example, Pause( ) and Resume( ) instructions can be used to control the operation of the preview state 404.

Therefore, using the state machine 400 provided by the ICamera system, it is possible for applications to control a device's camera resource to acquire still images and video clips. It is also possible to modify the state machine 400 to add, delete, change, or rearrange states, and/or the operation of API instructions to navigate the states without deviating from the scope of the embodiments. Thus, virtually any type of state machine may be provided by the ICamera system to allow applications to control the camera resource of the device.

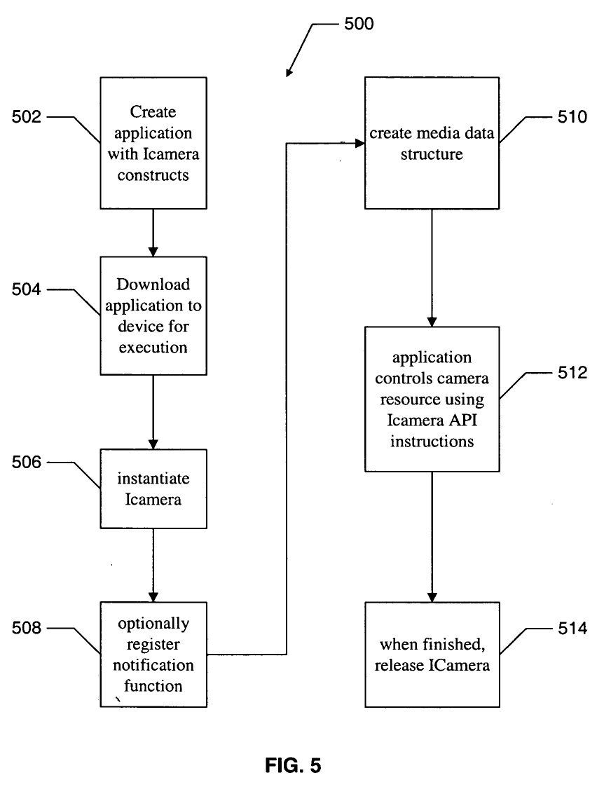

FIG. 5 shows one embodiment of a method 500 for operating an ICamera system on a device to allow an application to control a camera resource on the device. It will be assumed that the device is executing a BREW runtime environment and includes one embodiment of the ICamera system as described herein.

At block 502, an application is created using ICamera constructs so that it may control a camera resource on the device by utilizing a simple API interface provided by the ICamera system. For example, application developers create applications that execute on portable devices and perform various camera functions. The applications include ICamera API instructions to interface with the ICamera system and thereby control the operations of the device's camera according to a state machine (i.e., state machine 400 shown in FIG. 4).

At block 504, the application with ICamera API instructions is downloaded to the portable device for execution. For example, the application may be downloaded to the device via the wireless data network 108. The application may execute immediately, or be stored in memory and executed at a later time.

At block 506, the application executes and instantiates the ICamera system. For example, the application executes under the runtime environment operating on the device. During execution, the application instantiates the ICamera system so that it may control the camera resources of the device.

At block 508, the application registers a notification function if it is desirable to received asynchronous events from the ICamera system. For example, selected camera events can trigger a notification to the application.

At block 510, a media data structure is created and initialized based on the camera resource and/or desired media encoding characteristics. For example, in one embodiment, a media data type is derived based on file extension, file content, or file encoding.

At block 512, the application issues ICamera API instructions to the ICamera system, which in turn, operates to control the camera resource on the portable device. For example, the application may issue instructions to perform any of the functions described in the state machine 400 to control the operation of the camera resource. Thus, the application may acquire snapshots, video, or control camera parameters regardless of the type of camera resource available on the device. As a result, the camera system operates to eliminate any potential compatibility problems between the device's camera resource and the application.

At block 514, after the application has completed performing camera functions the ICamera system is no longer needed and it is released.

It should be noted that the method 500 is just one embodiment and that it is possible to make changes, additions, deletions, and/or rearrangements of the method steps without deviating from the scope of the described embodiments.

Implementation Example

The following is an implementation example to illustrate how in one embodiment the ICamera system is instantiated and a camera resource is controlled by an application downloaded to a portable device. The example includes references to the corresponding blocks in the method 500 of FIG. 5 and it is assumed that the runtime environment used by the portable device is the BREW environment. In the example, “CApp” is an instance of a BREW applet global structure.

static void App_CameraPreview(CApp * pme)
{
int nRet;
AEEMediaData md;
// Create Media Data structure (FIG. 5-block 510)
md.clsData = MMD_FILE_NAME;
md.pData = (void *)“albuw/snapshot.jpg”;
md.dwSize = 0;
// Activate the ICamera system and put in Ready state (FIG. 5-block 508)
nRet = ISHELL_CreateInstance(pme->a.pIShell,
AEECLSID_CAMERA,
&pme->m_pICamera);
// If successful, register App_CameraNotify( )
as the registered callback for
ICamera events (FIG. 5-block 508)
if (SUCCESS != nRet)
DisplayErrorDlg(pme, IDS_ERR_CREATECAMERA);
else if (SUCCESS != ICAMERA_RegisterNotify(pme->m_pICamera,
App_CameraNotify, pme))
DisplayErrorDlg(pme, IDS_ERR_REGISTERNOTIFY);
// Begin the preview (FIG. 5-block 512)
else if (SUCCESS != ICAMERA_Preview(pme->m_pIMedia))
DisplayErrorDlg(pme, IDS_ERR_PLAY);

Multiple Camera Resources

In one embodiment, the ICamera system operates to allow an application to control multiple camera resources on a single device. For example, the device may include a low-resolution camera to acquire still images and a high-resolution camera to acquire video clips. In this embodiment, two versions of the ICamera system can be instantiated to allow the application to control the two camera resources. For example, one ICamera API is used by the application to control the low-resolution camera, and a second ICamera API is used by the application to control the high-resolution camera. For example, one camera can be used for video-telephony and another camera as DSC/Camcorder.

For clarity of the description, drawings showing the operation of two or more ICamera systems on a device are not provided. However, since each ICamera system operates as described herein, such drawings would be redundant and unnecessary. During operation, the application instantiates first and second versions of the ICamera system thereby activating first and second ICamera APIs. The application thereafter executes instructions associated with either API to control the corresponding camera resource. Thus, embodiments of the ICamera system can be used to allow an application to control virtually any number of camera resources on a device.

In one or more embodiments, a camera system including methods and apparatus has been described that operates to allow an application to control one or more camera resources on a resource-limited portable device having an embedded controller. Accordingly, while one or more embodiments of the methods and apparatus have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

1. A method for operating a camera system to allow an application to control a camera resource in a portable device, the method comprising:
activating the camera system, wherein the camera system is operable to control the camera resource;
providing an application program interface (API) to receive instructions from the application;
receiving an instruction from the application via the API, wherein the instruction identifies a camera function to be performed; and
performing the camera function identified by the instruction.

2. The method of claim 1, wherein the step of activating comprises interfacing the camera system with one or more native modules that interface with the camera resource.

3. The method of claim 1, further comprising generating a media data structure to store data obtained from the camera resource.

4. The method of claim 1, wherein the step of performing the camera function comprises:
providing a state machine that identifies functions associated with the camera resource; and
navigating the state machine based on the instruction to perform the camera function.

5. The method of claim 1, wherein the portable device comprises a second camera resource, and the method comprises:
activating a second camera system, wherein the second camera system is operable to control the second camera resource;
providing a second application program interface (API) to receive instructions from the application;
receiving a second instruction from the application via the second API, wherein the second instruction identifies a camera function to be performed by the second camera resource; and
performing the camera function identified by the second instruction.

6. The method of claim 1, wherein the portable device is a wireless device.

7. Apparatus for operating a camera system to allow an application to control a camera resource in a portable device, the apparatus comprising:
means for activating the camera system, wherein the camera system is operable to control the camera resource;
means for providing an application program interface (API) to receive instructions from the application;
means for receiving an instruction from the application via the API, wherein the instruction identifies a camera function to be performed; and
means for performing the camera function identified by the instruction.

8. The apparatus of claim 7, wherein the means for activating comprises means for interfacing the camera system with one or more native modules that interface with the camera resource.

9. The apparatus of claim 7, further comprising means for generating a media data structure to store data obtained from the camera resource.

10. The apparatus of claim 7, wherein the means for performing the camera function comprises:
means for providing a state machine that identifies functions associated with the camera resource; and
means for navigating the state machine based on the instruction to perform the camera function.

11. The apparatus of claim 7, wherein the portable device comprises a second camera resource, and the apparatus comprises:
means for activating a second camera system, wherein the second camera system is operable to control the second camera resource;
means for providing a second application program interface (API) to receive instructions from the application;
means for receiving a second instruction from the application via the second API, wherein the second instruction identifies a camera function to be performed by the second camera resource; and
means for performing the camera function identified by the second instruction.

12. The apparatus of claim 7, wherein the portable device is a wireless device.

13. A computer-readable medium comprising instructions, which when executed by a processor in a portable device, operate to provide a camera system that allows an application to control a camera resource in the portable device, the computer-readable media comprising:
instructions for activating the camera system, wherein the camera system is operable to control the camera resource;
instructions for providing an application program interface (API) to receive API instructions from the application;
instructions for receiving an API instruction from the application via the API, wherein the API instruction identifies a camera function to be performed; and
instructions for performing the camera function identified by the API instruction.

14. The computer-readable media of claim 13, wherein the instructions for activating comprise instructions for interfacing the camera system with one or more native modules that interface with the camera resource.

15. The computer-readable media of claim 13, further comprising instructions for generating a media data structure to store data obtained from the camera resource.

16. The computer-readable media of claim 13, wherein the instructions for performing comprise:
instructions for providing a state machine that identifies functions associated with the camera resource; and
instructions for navigating the state machine based on the API instruction to perform the camera function.

17. The computer-readable media of claim 13, wherein the portable device comprises a second camera resource, and the computer-readable media comprises:
instructions for activating a second camera system, wherein the second camera system is operable to control the second camera resource;
instructions for providing a second application program interface (API) to receive API instructions from the application;
instructions for receiving a second API instruction from the application via the second API, wherein the second API instruction identifies a camera function to be performed by the second camera resource; and
instructions for performing the camera function identified by the second API instruction.

18. The computer-readable media of claim 13, wherein the portable device is a wireless device.

19. Apparatus for operating a camera system to allow an application to control a camera resource in a portable device, the apparatus comprising:
logic for activating the camera system, wherein the camera system is operable to control the camera resource;
logic for providing an application program interface (API) to receive instructions from the application;
logic for receiving an instruction from the application via the API, wherein the instruction identifies a camera function to be performed; and
logic for performing the camera function identified by the instruction.

20. The apparatus of claim 19, wherein the logic for activating comprises logic for interfacing the camera system with one or more native modules that interface with the camera resource.

21. The apparatus of claim 19, further comprising logic for generating a media data structure to store data obtained from the camera resource.

22. The apparatus of claim 19, wherein the logic for performing the camera function comprises:
logic for providing a state machine that identifies functions associated with the camera resource; and
logic for navigating the state machine based on the instruction to perform the camera function.

23. The apparatus of claim 19, wherein the portable device comprises a second camera resource, and the apparatus comprises:
logic for activating a second camera system, wherein the second camera system is operable to control the second camera resource;
logic for providing a second application program interface (API) to receive instructions from the application;
logic for receiving a second instruction from the application via the second API, wherein the second instruction identifies a camera function to be performed by the second camera resource; and
logic for performing the camera function identified by the second instruction.

24. The apparatus of claim 19, wherein the portable device is a wireless device.
